(19) United States
(12) Patent Application Publication
(10) Pub. No.: US 2008/0252045 A1
(43) Pub. Date: Oct. 16, 2008

(54) Single-Post, Height Adjustable Cart

(76) Inventors: Alfred P. Rossini, Southboro, MA (US); Jeffrey M. Silverman, Stoughton, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/101,315

(22) Filed: Apr. 11, 2008

Related U.S. Application Data
(60) Provisional application No. 60/911,181, filed on Apr. 11, 2007.

(51) Int. Cl. B62B 5/00

(52) U.S. Cl. 280/659; 74/469

(57) ABSTRACT

Provided is a roller set assembly system of a height adjustable, single-post for use with a cart comprising a base section; an upper, adjustable-height workspace; and an intermediate section connecting the base section and the upper working section. The length of the post is adapted for manual adjustment by a user for optimal height. The intermediate section comprises an optionally removable spring member (e.g., a gas spring) within the post to assist in providing upward force necessary to lengthen the post; and a roller set assembly construction that inhibits twisting of the post and as creates a rolling motion between movable members thereby counteracting friction and torque, and facilitating height adjustment.

### CROSS REFERENCE TO RELATED APPLICATIONS

This application claims the benefit of and the same priority of U.S. Provisional application No. 60/911,181, filed Apr. 11, 2007, the entire disclosure of which is incorporated herein by reference.

### FIELD OF THE INVENTION

The present invention relates to an adjustable, single post support for a mobile workstation.

### BACKGROUND OF THE INVENTION

Mobile carts used as workstations are known. These carts are commonly used in medical facilities and on manufacturing floors. They are typically adapted to carry a computer, and usually have additional shelf space available for the user, for such things as paper work, medications, and/or portable medical equipment.

These carts are typically used by many different people over the course of a day or a week. It is thus important that these carts have certain ergonomic features. For example, it is desirable for the user to be able to adjust the height of the cart to place the work surfaces and computer keyboard and mouse at a convenient and comfortable position.

Such carts typically comprise a wheeled base and an upper working section connected by an adjustable-length intermediate section, which typically includes a gas spring. The spring is operated by a lever. As there can be a substantial amount of weight carried at the top of the post, it is awkward and relatively difficult to lift the working section to a higher working position. This has been especially problematic in medical facilities, as often times the users of these carts are female nurses who lack the strength to easily lift the working section to a comfortable working height. To be lowered, the lever is operated and the front handle is pushed down. However, as the handle is offset from the axis of motion, substantial torque is created, which increases the amount of force needed to adjust the worksurface. For this reason, many such carts place the handle back near the centerline of the post. This makes the handle awkward to reach. For people of less than normal height, the handle placement makes it very difficult for them to develop the leverage necessary to push down on the worksurface. The height-adjustment feature is thus less likely to be properly employed by users.

### SUMMARY OF THE INVENTION

The invention features a single-post, height adjustable cart, wherein the cart comprises a base section, an upper, adjustable height workspace, and an intermediate section connecting the base section and the upper workspace section. The intermediate section comprises an upwardly-extending post, wherein the length of the post is adapted to be manually altered by a user. The upwardly extending post comprises at least two relatively slidable, nesting members. The internal sliding member of the post comprises an optionally removable spring member (e.g., a standard locking spring (e.g., a gas spring)) to assist in providing upward force necessary to extend the post.

Provided is a roller post support system for facilitating vertical motion of at least two relatively slidable members of the upwardly-extending post. The roller post system is comprised within the intermediate section of a height adjustable cart. The provided roller post support system comprises at least one first roller set assembly comprising a roller support member, at least one roller set, at least one spring member, and a roller set assembly support. The roller set, roller support member and roller set assembly support are connected, and a spring member is coupled to the roller set assembly support in order to provide a spring force against the roller support member. The provided roller post support system further comprises at least one second roller set assembly comprising a roller support member, at least one roller set, and a roller set assembly support. The roller set, roller support member and roller set assembly support are also connected in the second roller set assembly. The first roller set assembly and the second roller set assembly are attached to an upper inside portion of a first relatively slidable member of the upwardly extending post. Further, the first and the second roller set assemblies are preferably arranged so as to accommodate a second relatively slidable member and to maintain the second relatively slidable member in proper radial alignment with the first relatively slidable member.

In some embodiments, a roller post support system comprises one first roller set assembly and two second roller set assemblies. In certain embodiments the second relatively slidable member is a triangular shaped member. In one embodiment a first roller set assembly is arranged to support a long edge of a triangular shaped slidable member, and two second roller set assemblies are arranged to support two short edge sides of a triangular shaped slidable member. When a single first roller set assembly and two second roller set assemblies are arranged, the first roller set assembly may be attached at a side of the first relatively slidable member opposite to a side where a user handle adjustment is located. For example, where a handle is located at the front edge of an upper workspace section, a first roller set assembly may be attached to the rear side of the first relatively slidable member.

In some embodiments, a roller post support system comprises two first roller set assemblies and two second roller set assemblies. In certain embodiments, a second relatively slidable member is a rectangular shaped member; in some embodiments, the second relatively slidable member is a square shaped member. In one embodiment, the first roller set assemblies may be arranged to be attached at a side of the first relatively slidable member opposite to a side where a user handle adjustment is located. Accordingly, the second roller set assemblies may be arranged to be attached at a side of the post where a user handle adjustment is located. For example, where a handle is located at the front edge of an upper workspace section, the first roller set assemblies may be attached to the rear side of the first relatively slidable member, and the second roller set assemblies may be attached to the front side of the first relatively slidable member.

In some embodiments, a first roller set assembly comprises a roller support member, two roller sets, two spring members, and a roller set assembly support. In some embodiments, a second roller set assembly comprises a roller support member, two roller sets, and a roller set assembly support.

A roller set may include one or more bearing members fixed on a roller support member. In certain embodiments a roller set comprises a single bearing member, two bearing members, or more.

In certain embodiments, a roller post support system comprises one first roller set assembly comprising a roller support member, two roller sets, two spring members, and a roller set assembly support; and two second roller set assemblies comprising a roller support member, two roller sets, and a roller set assembly support.

In some embodiments, a roller post support system comprises two first roller set assemblies comprising a roller support member, two roller sets, two spring members, and a roller set assembly support; and two second roller set assemblies comprising a roller support member, two roller sets, and a roller set assembly support.

In certain embodiments, a first roller set assembly of a roller post support system comprises a roller support member, at least one roller set, one spring member, a roller set assembly support, and an adjustable set screw. In some embodiments, a first roller set a first roller set assembly of a roller post support system comprises a roller support member, two roller sets, one spring member, a roller set assembly support, and an adjustable set screw.

In one embodiment a roller post support system comprises a single first roller set assembly comprising a roller support member, two roller sets, one spring member, a roller set assembly support, and an adjustable set screw. In certain embodiments, a roller post support system comprises one first roller set assembly comprising a roller support member, two roller sets, one spring member, a roller set assembly support, and an adjustable set screw; as well as two second roller set assemblies comprising a roller support member, two roller sets, and a roller set assembly support.

In other embodiments, a roller post support system comprises two first roller set assemblies comprising a roller support member, two roller sets, one spring member, a roller set assembly support, and an adjustable set screw; and two second roller set assemblies comprising a roller support member, two roller sets, and a roller set assembly support, wherein the second relatively slidable member is a rectangular shaped member.

### BRIEF DESCRIPTION OF THE DRAWINGS

Other objects, features and advantages will occur to those skilled in the art from the following description of certain preferred embodiments and the accompanying drawings in which:

FIG. 1 depicts perspective views of an assembled embodiment of the height adjustable rolling cart of the invention. FIG. 1A is the embodiment depicted in the lowest adjustable position, and FIG. 1B is the same embodiment raised to the highest adjustable position.

FIG. 2 depicts an exploded view of an embodiment of the invention.

FIG. 3 depicts a separated view of a roller post assembly embodiment comprising a three roller set system.

FIG. 4 depicts an assembled view of a roller post assembly embodiment comprising a three roller set system.

FIG. 5 depicts exploded views of an embodiment of an adjustable rolling cart of the invention. FIG. 5A depicts an exploded view of a triangular sliding member, assembled with a standard locking gas spring. FIG. 5B depicts a detailed exploded view of the internal space of a sliding member and a bolt connecting to a standard locking gas spring. FIG. 5C depicts an exploded view of a sliding member assembled with a standard locking gas spring, and a relatively slidable, nesting, member. FIG. 5D depicts an exploded view of another embodiment of a sliding member with brackets attached, assembled with a standard locking gas spring, and a relatively slidable, nesting, member. FIG. 5E depicts an exploded view of a standard locking gas spring and a relatively slidable, nesting, member. FIG. 5F depicts a side view assembly of the relatively slidable, nesting member, and a standard locking gas spring and its release valve.

FIG. 6 depicts exploded and assembled views of roller sets of an embodiment of the invention. FIG. 6A depicts an exploded perspective of a roller set. FIG. 6B depicts an assembled view of a roller set; and FIG. 6C depicts a perspective view of a roller set.

FIG. 7 depicts exploded and assembled views of roller sets of an embodiment of the invention. FIG. 7A depicts an exploded perspective of a roller set. FIG. 7B depicts an assembled view of a roller set; and FIG. 7C depicts a perspective view of a roller set.

FIG. 8 depicts views of a spring member of an embodiment of the invention. FIG. 8A depicts a perspective view of a spring member; FIG. 8B depicts a top view of the spring member; and FIG. 8C depicts a side view of the spring member.

FIG. 9 depicts a separated view of a roller post assembly embodiment comprising a four roller set system.

FIG. 10 depicts an assembled view of a roller post assembly embodiment comprising a four roller set system.

FIG. 11 depicts exploded views of an embodiment of an adjustable rolling cart of the invention. FIG. 11A depicts an exploded view of an outer relatively slidable nesting member assembled with an inner relatively slidable nesting member. FIG. 11B depicts an exploded view of a sliding member with brackets, assembled with the outer relatively slidable, nesting, member, and an inner relatively slidable nesting member. FIG. 11C depicts an exploded view of a sliding member assembled with an inner relatively slidable nesting member and an outer relatively slidable nesting member and a removable gas spring attached to an upper bracket and its release valve.

FIG. 12 depicts exploded and assembled views of roller sets of an embodiment of the invention. FIG. 12A depicts an exploded perspective of a roller set. FIG. 12B depicts an assembled view of roller set; and FIG. 12C depicts a perspective view of roller set.

FIG. 13 depicts views of a spring member of an embodiment of the invention. FIG. 13A depicts a perspective view of a spring member; FIG. 13B depicts a top view of the spring member; and FIG. 13C depicts a side view of the spring member.

FIG. 14 depicts views of a bracket used in an embodiment of a roller post assembly. FIG. 14A depicts a top view; FIG. 14B depicts a front view; FIG. 14C depicts a side view; and FIG. 14D depicts a perspective view of a bracket. FIG. 14E depicts a front view, and FIG. 14F depicts a side view of a bracket with a set screw insert.

### DESCRIPTION OF CERTAIN PREFERRED EMBODIMENTS OF THE INVENTION

This invention features a single-post, height adjustable rolling cart, comprising a rolling base section; an upper working section, comprising at least a first shelf to provide an adjustable-height workspace; and an intermediate section connecting the base section and the upper working section, comprising an upwardly-extending post. The length of the post is adapted to be manually altered by a user for optimal height adjustment. The intermediate section further comprises a spring member (e.g., a gas spring) within the post to assist in providing upward force necessary to lengthen the post.

The invention allows a user to easily adjust the height of a workspace in order to achieve comfortable and ergonomically-correct positioning of the workspace. Adjustment can be accomplished with minimal manual force on a handle located at the front of the cart. In certain embodiments, the handle is well spaced from the axis of motion of the post.

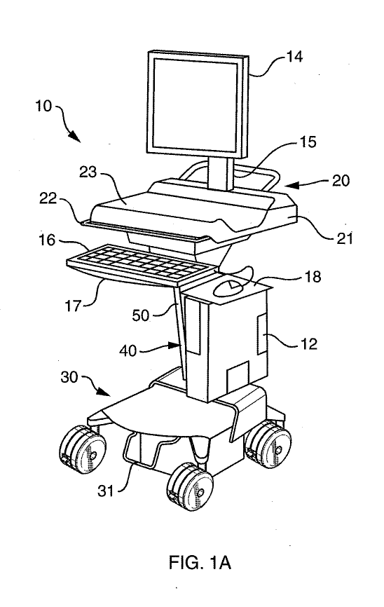

A single-post, height adjustable rolling cart of the invention is shown in FIG. 1. FIG. 1A is a perspective view of a height-adjustable rolling cart in the lowest position, and FIG. 1B is the same view of the cart raised to its highest position. Cart 10 comprises rolling base section 30, upper working section 20, and intermediate section 40 that comprises upwardly-extending post 50. The rolling base section 30 comprises a foot pedal release 31 that is operably connected to a standard locking spring (e.g., a gas spring) release to allow for adjustment of post 50 while engaged.

Upper section 20 may include additional workspace functions, such as a keyboard support surface 17 that supports keyboard 16 and may optionally include a retractable mouse tray 18. Section 20 may further include one or more additional surfaces such as upper portion 21 that defines a first shelf and/or working surface 23 which in may comprise an optional removable cover member that exposes a cavity inside of portion 21. In certain embodiments, portion 21 may comprise a space to accommodate additional workspace equipment (e.g., a laptop computer, a thin client computer, or the like), as desired. In certain embodiments, workspace activity (e.g., computing) is accomplished with equipment 12 (e.g., a desktop computer) that is coupled to the cart in an appropriate manner. Additional equipment (e.g., a display such as a flat panel monitor 14) may be still further included and may optionally project above portion 21, supported by post 15 in the upper working section 20. A front projecting handle 22 is included in the upper working section 20 to allow the user to easily roll the cart, as well as to push down or lift up on upper section 20 to adjust height of the upper working section 20.

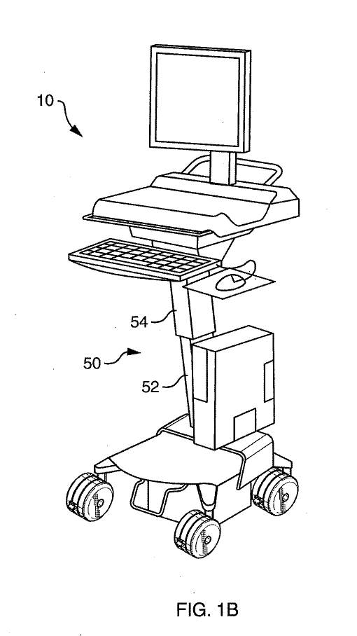

As shown in the height-adjusted view of the single-post, height adjustable rolling cart depicted in FIG. 1B and FIG. 2, adjustable post 50 comprises two relatively slidable, nesting, generally rectangular-shaped members 52 and 54. A standard locking spring (e.g., a gas spring) is located inside the internal sliding member 56, and is operably connected to the top end of sliding member 56 to facilitate raising and/or lowering upper section 20. The standard locking spring is fixably connected to the top portion of sliding member 56 as well as to the bottom portion of sliding member 52 or a portion of base 30 so as to remain fixed to base section 30. A release pedal is included to allow for release of the spring to facilitate raising and/or lowering height adjustment of post 50 while a release is engaged.

Some of the functional aims of post 50 are to allow the user to relatively easily move the upper working section between the lowest position shown in FIG. 1A and the highest position shown in FIG. 1B, and any location between the two. The post is designed such that a user can accomplish adjustment of height by gently lifting up or pushing down on handle 22 while engaging a foot pedal release 31. Handle 22 is offset from the axis of motion of post 50. This offset has created a problem in past similar rolling carts, as described above, due to the torque created when the user places a force on handle 22 that is removed from the axis of motion. For example, the present invention allows for a force to be applied on a handle that is removed from the axis of motion by at least about two inches, at least about four inches, at least about six inches, at least about eight inches, at least about ten inches, or at least about twelve inches from the axis of motion. In certain embodiments, a handle is removed from the axis of motion by about two inches, about three inches, about four inches, about five inches, about six inches, about seven inches, about eight inches, about nine inches, about ten inches, about eleven inches or about twelve inches. In some embodiments, a handle is removed from the axis of motion by between six and nine inches, and in certain embodiments the handle is removed from the axis of motion by about eight and a half inches.

The torque issue is overcome in this invention by creating a tight fit between two relatively movable members of the post design. The fit is accomplished with a roller set assembly construction that inhibits twisting of one member relative to the other. Additionally, the construction accomplishes a rolling motion between the two members that counteracts friction and torque, and facilitates height adjustment.

One embodiment of construction of a height-adjustable, single-post 50 is depicted in FIG. 2. Generally member 56 has structure 57 at its top end. Structure 57 supports the upper working section of the cart. Member 56 is adapted to slide within member 52. Outer member 54 has top flange members 55a and 55b that are coupled to upper flange members 59a and 59b of member 57. Member 52 fits within member 54. Optionally, member 54 has spacers 53 fixed on the inside surface of member 54 to facilitate motion of member 54 along member 52. Alternatively, the inside surface of member 54 may be partially or wholly coated to achieve similar effect.

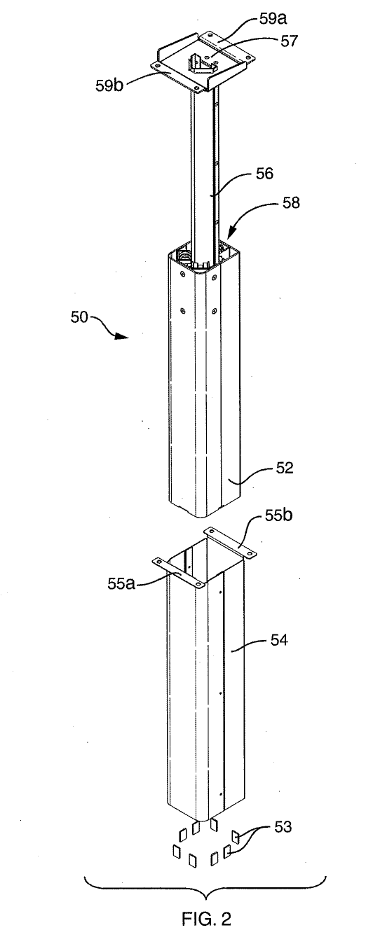

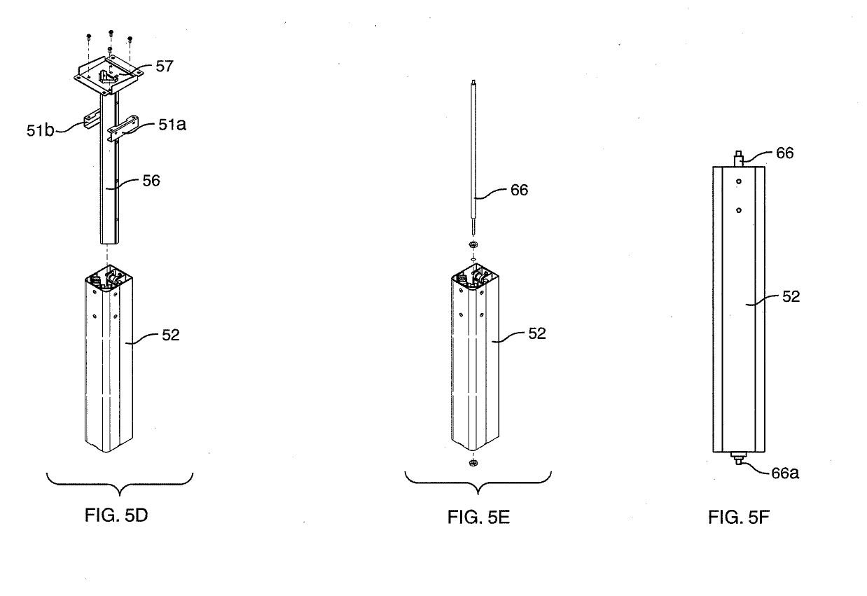

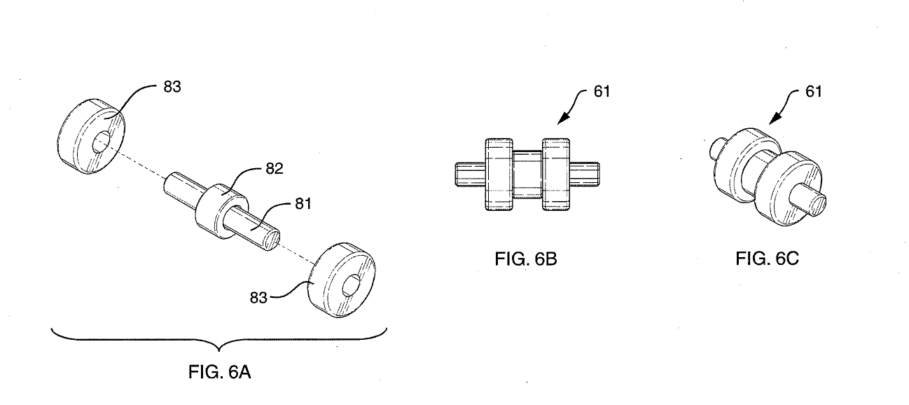

Details of construction of the embodiment shown in FIG. 2 are depicted in FIGS. 3 through 8. Member 52 includes three rollers set assemblies at its upper end that are sized to tightly fit triangular sliding member 56. The roller set assemblies in member 52 comprise a roller post support system 58. This arrangement is accomplished with two types of roller set assemblies. One roller set assembly type 60 comprises roller support member 59 that supports two spaced roller sets 61, the construction of which is detailed in FIGS. 6A through 6C. Roller set 61 comprises bearing members 83 that are fitted on shaft 81 and separated by spacer 82. The other two roller set assemblies 62 are very similar to roller set assembly 60, with the primary difference being that the bearing members 93 (FIGS. 7A through 7C) are closer together than the bearing members 83 of roller set 61. This is to accommodate the particular construction of triangular member 56 which has two narrow sides that contact roller sets 62, and a wider rear side that contacts roller set 60. The concept of these roller sets is to create vertically-spaced sets of multiple bearing members on each of the three sides of triangular member 56, to maintain member 56 in proper radial alignment with member 52 in order to inhibit twisting of the upper working section, while at the same time providing for a low-friction, smooth upward and downward motion of member 56 relative to member 52. This allows the upper working section to be easily moved up and down by appropriate force on handle 22.

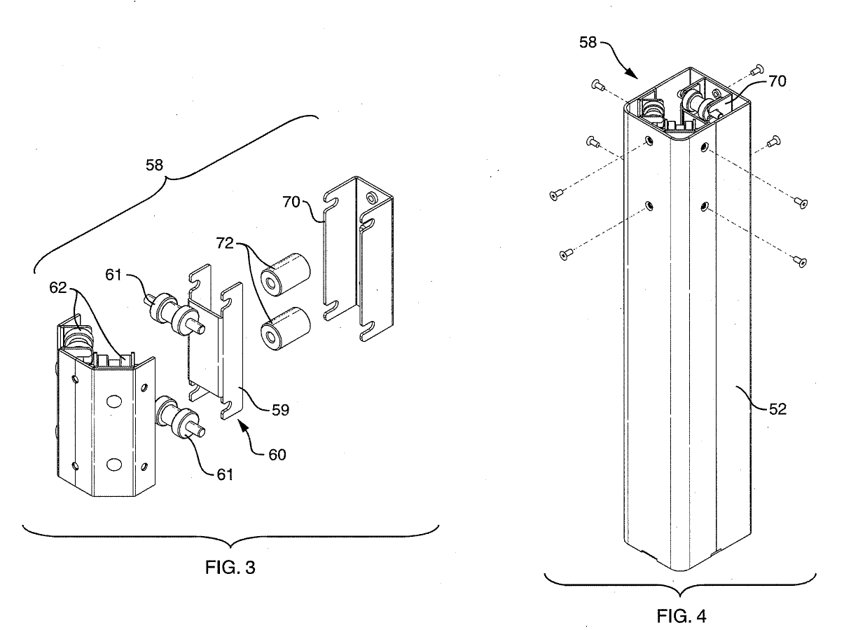

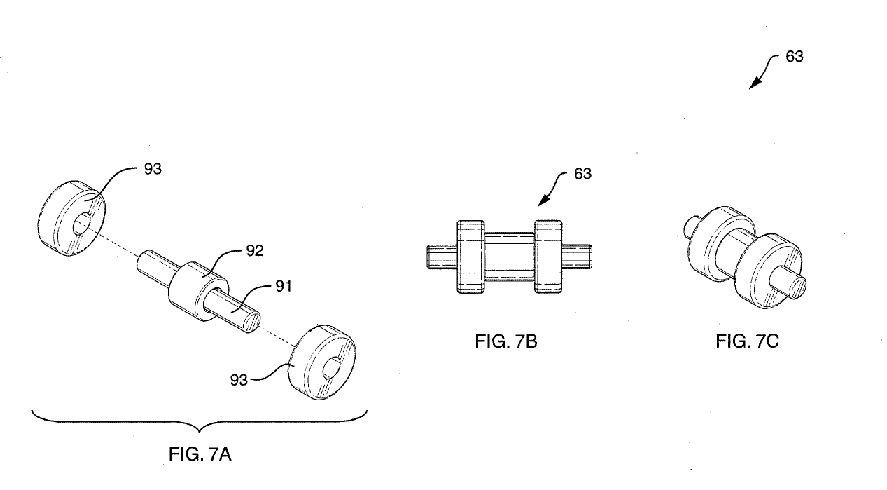

An additional aspect of a roller post support system construction is accomplished with at least one spring member 72 that is coupled to support 70 that is itself attached to roller set assembly 60 as shown in FIG. 3; and is also fixed to the back side of member 52 as shown in FIG. 4. Spring members 72 are sized such that they rest against the back of member 59 when member 59 is placed into member 70 with the projecting ends of shaft 81 of the two roller sets 61 fitted into the slots at the top and bottom of member 70. Support 70 may comprise boss members to assist in positioning and support of spring members 72. The function of members 72 is to create a spring force on member 59 that pushes it towards the axis of motion of member 56, to maintain a tight fit between member 56 and member 52. The resulting spring force accounts for minute variations in the dimensions of member 56 along its length. Details of member 72 are depicted in FIGS. 8A through 8C. It has been found that making spring members of a sufficiently stiff material (e.g., a urethane a polyurethane, a neoprene) provides sufficient stiffness and urging force to supply sufficient spring force to achieve the desired results in our system. In one embodiment, for example, we have used a urethane material with a durometer of 80 A (under ASTM D2240) for production of spring members 72 to achieve desired results. Alternative constructions of spring members can, of course, be accomplished with various types of more traditional spring members and other elastic materials.

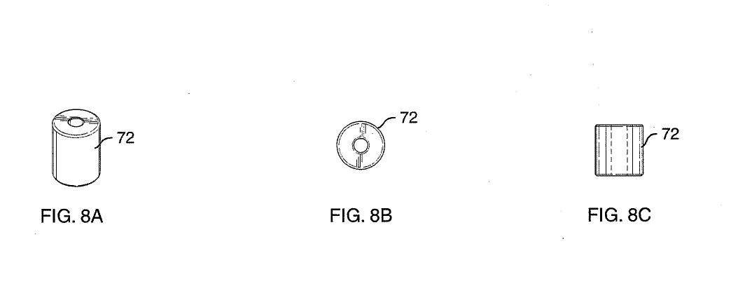

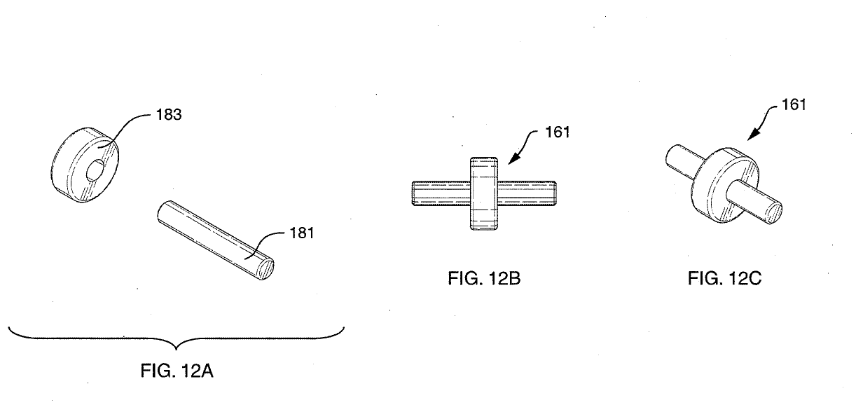

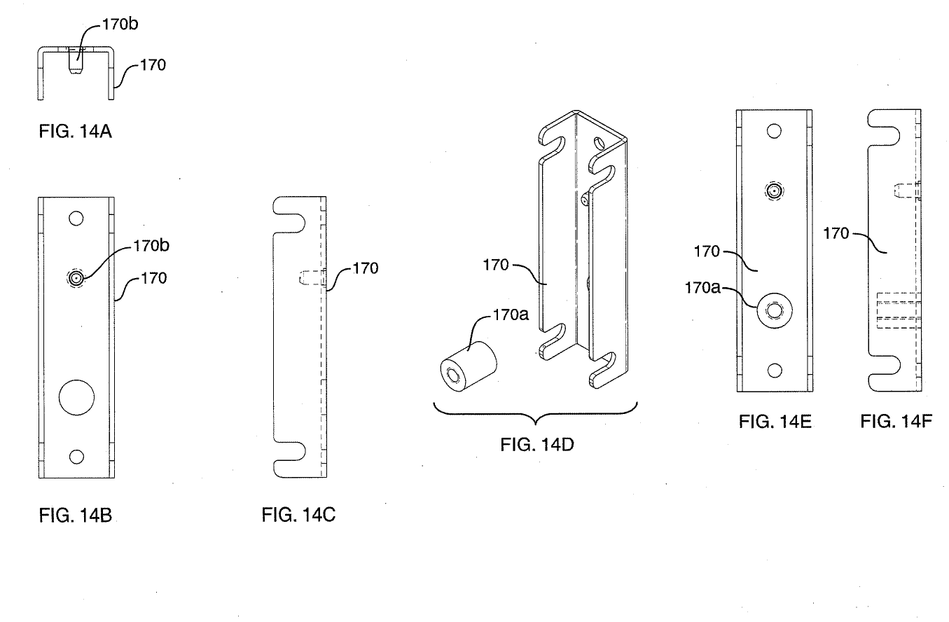

Details of construction of another embodiment are depicted in FIGS. 9 through 14. Member 152 includes four rollers set assemblies at its upper end that are sized to tightly fit a rectangular sliding member 156. The roller set assemblies in member 152 comprise a roller post support system 158. This arrangement is accomplished with two types of roller set assemblies. One roller set assembly type 160 comprises roller support member 159 that supports two spaced roller sets 161, the construction of which is detailed in FIGS. 12A through 12C. Roller set 161 comprises bearing member 183 that is fitted on shaft 181. The other two roller set assemblies 162 are very similar to roller set assembly 62 described above (FIGS. 7A through 7C). This is to accommodate the particular construction of rectangular member 156 which has two sides that contact roller set assemblies 162, and two sides that contact roller set assemblies 160. The concept of these roller set assemblies is to create vertically-spaced sets of multiple bearing members on each of the sides of rectangular member 156, to maintain member 156 in proper radial alignment with member 152 and to inhibit twisting of the upper working section, while at the same time providing a low-friction, smooth upward and downward motion of member 156 relative to member 152. This allows the upper working section to be easily moved up and down by appropriate force on handle 22.

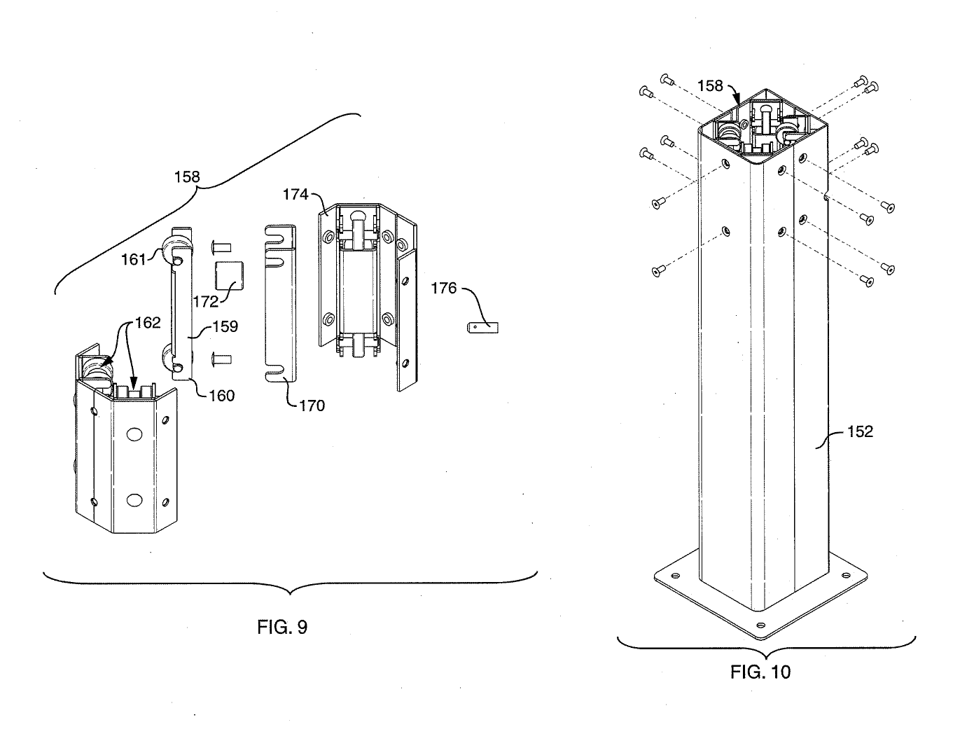

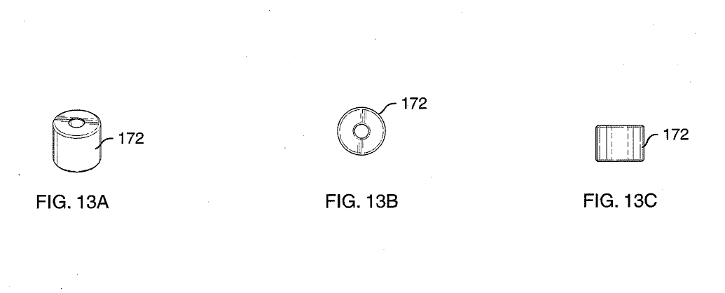

An additional embodiment of a roller post support system construction is accomplished with a spring member 172 that is coupled to support 170 that is itself attached to roller set assembly 160 as shown in FIG. 9; and is also fixed to the back side of member 152 as shown in FIG. 10. Spring member 172 is sized such that it rests against the back of member 159 when member 159 is placed into member 170 with the projecting ends of shaft 181 of the two roller sets 161 fitted into the slots at the top and bottom of member 170. Support 170 may comprise boss member 170b to assist in positioning and support of spring member 172. The function of member 172 is to create a spring force on member 159 that pushes it towards the axis of motion of member 156, to maintain a tight fit between member 156 and member 152. The resulting spring force accounts for minute variations in the dimensions of member 156 along its length. Details of member 172 are depicted in FIGS. 13A through 13C.

As discussed above, it has been found that making spring members of a sufficiently stiff material (e.g., a urethane a polyurethane, a neoprene) provides sufficient stiffness and urging force to supply sufficient spring force to achieve the desired results in our system. In one embodiment, for example, we have used a urethane material with a durometer of 80 A (under ASTM D2240) for production of spring member 172 to achieve desired results. As above, alternative constructions of spring members can, of course, be accomplished with various types of more traditional spring members and other elastic materials.

A further embodiment of a roller post support system construction is accomplished with an adjustable set screw inserted into set screw insert 170a that is incorporated as part of support 170 that is attached to roller set assembly 160. Set screw insert 170a is welded in support 170 to allow for insertion of an adjustable set screw. A set screw inserted into set screw insert 170a may extend beyond the set screw insert 170a to put additional pressure against the back of member 159 when member 159 is placed into member 170 with the projecting ends of shaft 181 of the two roller sets 161 fitted into the slots at the top and bottom of member 170 (see FIG. 9). Pressure from a set screw inserted into set screw insert 170a may be adjusted according to the desired setting to achieve sufficient spring force in conjunction with spring member 172 on member 159 to maintain a tight fit between member 156 and member 152. Slight adjustment of a set screw in set screw insert 170a may be sufficient to provide desired pressure for maintaining a tight fit between member 156 and member 152.

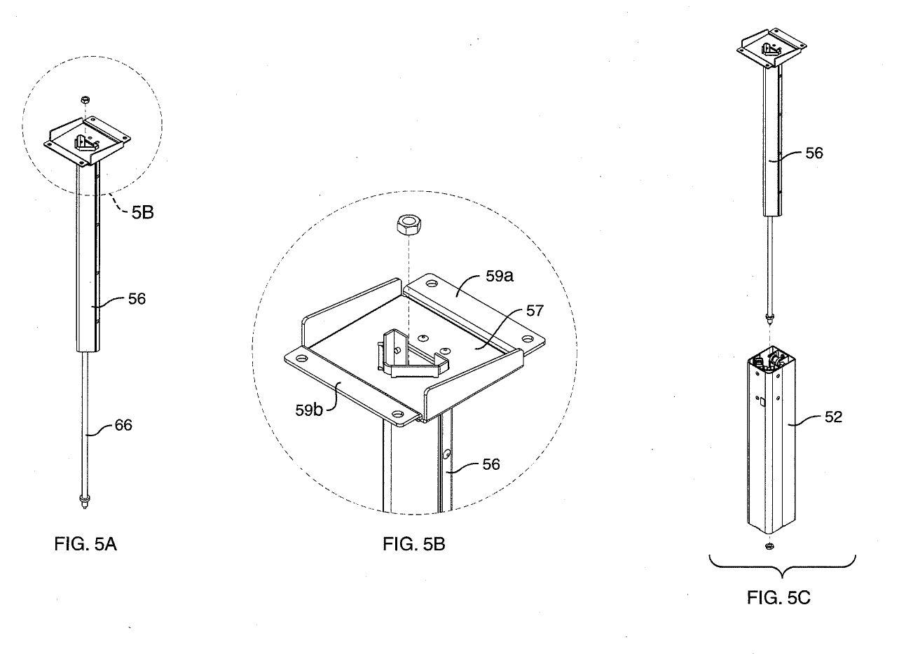

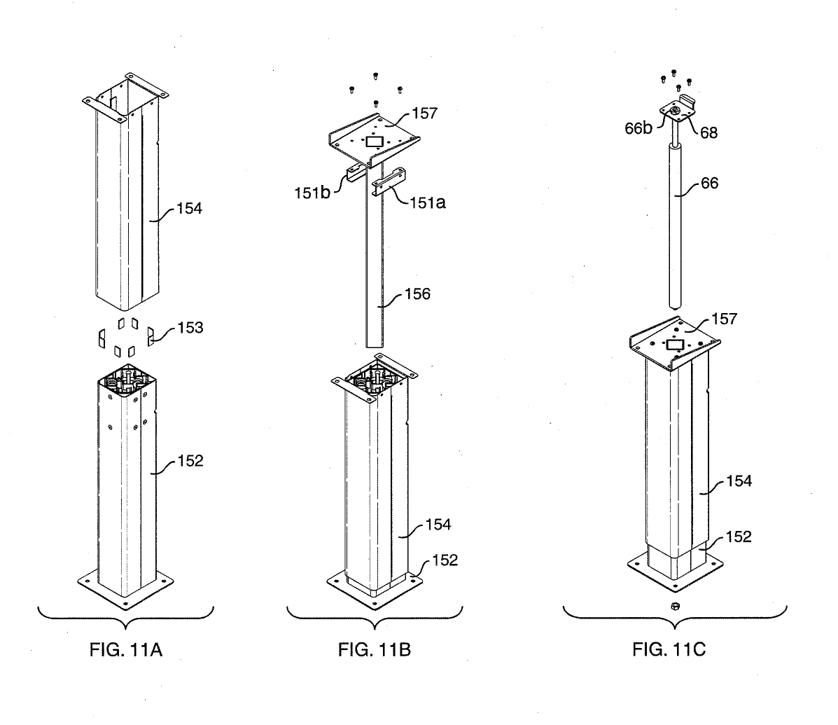

Another aspect of the invention comprises placement of a gas spring in the construction. As discussed above, a standard locking spring (e.g., a gas spring) is located inside the intermediate section 40. See FIG. 1. The standard locking gas spring 66 helps to support and balance the load of an upper section of an assembled cart, as well as to ease and facilitate the up-down motion and height adjustment. For example, a standard locking gas spring 66 is located inside internal sliding member 56/156, and may be operably connected to the top end of sliding member 56/156 to facilitate raising and/or lowering upper section 20. See FIG. 1, FIG. 5 and FIG. 11. The standard locking spring is fixably connected to the top portion of sliding member 56/156 as well as to the bottom portion of sliding member 52/152 or a portion of base 30 so as to remain fixed to base section 30. In one embodiment, standard locking gas spring 66 within member 56 is fixed to the base section at the bottom, as well as to structure 57 at the top end of member 56. Structure 57 at the top end of member 56 may comprise flanges 59a, 59b on opposing sides for connecting member 56 to upper section 20. Additionally, brackets 51a and 51b may be attached to structure 57 which rest against the top of member 52 when member 56 is lowered. A release pedal is included to allow for release of the spring to facilitate raising and/or lowering height adjustment of post 50 while a release is engaged. In one embodiment a foot pedal release is included at the base section 30, wherein the foot pedal release is operably connected to a release valve 66a at the lower end of the standard locking spring. See FIG. 1 and FIG. 5F. In one embodiment a hand pedal release is included at or near the handle 22 of upper section 20, wherein the hand pedal release is operably connected to a release valve 66b at the upper end of the standard locking spring. See FIG. 1 and FIG. 11C.

In still another embodiment, a removable standard locking spring is incorporated into the construction to facilitate assembly as well as allow for exchange of an appropriate standard locking spring to account for appropriate weight and size of an upper section 20. For example, internal sliding member 156 and structure 157 at its top end are adapted to allow for insertion of gas spring 66 after assembly of sliding member 156 and structure 157 with sliding members 152, 154 and a base section. See FIGS. 11B and 11C. A bracket 68 may be assembled on to the top of gas spring 66 to fix the spring in place and connect to structure 157, as well optionally to allow for spacing of a top release valve 66b. When a removable top assembly of the gas spring is incorporated in to the present system, an appropriate gas spring (and relevant force of a gas spring) having a desired spring force may be inserted to appropriately balance the load of the weight of the applicable workstation. The removable assembly provides ease of exchange in the present system.

Specific features of the invention are shown in some drawings and not others, however, this is for convenience only, as certain features can be combined as would be apparent to those skilled in the art. Other combinations of features would be apparent to those skilled in the field and are within the scope of the claims.

What is claimed is:

1. A single-post, height adjustable cart, comprising:
a rolling base section;
an upper working section comprising at least a first shelf, to provide an adjustable-height workspace; and
an intermediate section connecting the base section and the upper working section, comprising an upwardly-extending post, wherein the length of the post is adapted to be manually altered by a user;
wherein the upwardly-extending post comprises an optionally removable standard locking spring, and
wherein the intermediate section comprises a roller post support system for facilitating vertical motion of at least two relatively slidable members of the upwardly-extending post, the roller post support system comprising:
at least one first roller set assembly comprising:
a roller support member, at least one roller set, at least one spring member, and a roller set assembly support, wherein the roller set, roller support member and roller set assembly support are connected, and wherein a spring member is coupled to the roller set assembly support and also provides a spring force against the roller support member;
at least one second roller set assembly comprising: a roller support member, at least one roller set, and a roller set assembly support, wherein the roller set, roller support member and roller set assembly support are connected;
wherein the first roller set assembly and the second roller set assembly are attached to an upper portion of a first relatively slidable member, and wherein the first and the second roller set assemblies are arranged to accommodate a second relatively slidable member and to maintain the second relatively slidable member in proper radial alignment with the first relatively slidable member.

2. The single-post, height adjustable cart of claim 1 wherein the roller post support system comprises one first roller set assembly and two second roller set assemblies, wherein the second relatively slidable member is a triangular shaped member.

3. The single-post, height adjustable cart of claim 1 wherein the roller post support system comprises two first roller set assemblies and two second roller set assemblies, wherein the second relatively slidable member is a rectangular shaped member.

4. The single-post, height adjustable cart of claim 1 wherein the at least one first roller set assembly of the roller post support system comprises a roller support member, two roller sets, two spring members, and a roller set assembly support.

5. The single-post, height adjustable cart of claim 1 wherein the at least one second roller set assembly of the roller post support system comprises a roller support member, two roller sets, and a roller set assembly support.

6. The single-post, height adjustable cart of claim 1 wherein the roller post support system comprises one first roller set assembly comprising a roller support member, two roller sets, two spring members, and a roller set assembly support; and two second roller set assemblies comprising a roller support member, two roller sets, and a roller set assembly support, wherein the second relatively slidable member is a triangular shaped member.

7. The single-post, height adjustable cart of claim 1 wherein the roller post support system comprises two first roller set assemblies comprising a roller support member, two roller sets, two spring members, and a roller set assembly support; and two second roller set assemblies comprising a roller support member, two roller sets, and a roller set assembly support, wherein the second relatively slidable member is a rectangular shaped member.

8. The single-post, height adjustable cart of claim 1 wherein the at least one first roller set assembly of the roller post support system comprises a roller support member, two roller sets, one spring member, a roller set assembly support, and an adjustable set screw.

9. The single-post, height adjustable cart of claim 1 wherein the roller post support system comprises one first roller set assembly comprising a roller support member, two roller sets, one spring member, a roller set assembly support, and an adjustable set screw; and two second roller set assemblies comprising a roller support member, two roller sets, and a roller set assembly support, wherein the second relatively slidable member is a triangular shaped member.

10. The single-post, height adjustable cart of claim 1 wherein the roller post support system comprises two first roller set assemblies comprising a roller support member, two roller sets, one spring member, a roller set assembly support, and an adjustable set screw; and two second roller set assemblies comprising a roller support member, two roller sets, and a roller set assembly support, wherein the second relatively slidable member is a rectangular shaped member.

11. A roller post support system for facilitating vertical motion of at least two relatively slidable members comprising:
at least one first roller set assembly comprising:
a roller support member, at least one roller set, at least one spring member, and a roller set assembly support, wherein the roller set, roller support member and roller set assembly support are connected, and wherein a spring member is coupled to the roller set assembly support and also provides a spring force against the roller support member; at least one second roller set assembly comprising:
a roller support member, at least one roller set, and a roller set assembly support, wherein the roller set, roller support member and roller set assembly support are connected;
wherein the first roller set assembly and the second roller set assembly are attached to an upper portion of a first relatively slidable member, and wherein the first and the second roller set assemblies are arranged to accommodate a second relatively slidable member and to maintain the second relatively slidable member in proper radial alignment with the first relatively slidable member.

12. The roller post support system of claim 11 comprising one first roller set assembly and two second roller set assemblies, wherein the second relatively slidable member is a triangular shaped member.

13. The roller post support system of claim 11 comprising two first roller set assemblies and two second roller set assemblies, wherein the second relatively slidable member is a rectangular shaped member.

14. The roller post support system of claim 11 wherein the at least one first roller set assembly comprises a roller support member, two roller sets, two spring members, and a roller set assembly support.

15. The roller post support system of claim 11 wherein the at least one second roller set assembly comprises a roller support member, two roller sets, and a roller set assembly support.

16. The roller post support system of claim 11 comprising one first roller set assembly comprising a roller support member, two roller sets, two spring members, and a roller set assembly support; and two second roller set assemblies comprising a roller support member, two roller sets, and a roller set assembly support, wherein the second relatively slidable member is a triangular shaped member.

17. The roller post support system of claim 11 comprising two first roller set assemblies comprising a roller support member, two roller sets, two spring members, and a roller set assembly support; and two second roller set assemblies comprising a roller support member, two roller sets, and a roller set assembly support, wherein the second relatively slidable member is a rectangular shaped member.

18. The roller post support system of claim 11 wherein the at least one first roller set assembly comprises a roller support member, two roller sets, one spring member, a roller set assembly support, and an adjustable set screw.

19. The roller post support system of claim 11 comprising one first roller set assembly comprising a roller support member, two roller sets, one spring member, a roller set assembly support, and an adjustable set screw; and two second roller set assemblies comprising a roller support member, two roller sets, and a roller set assembly support, wherein the second relatively slidable member is a triangular shaped member.

20. The roller post support system of claim 11 comprising two first roller set assemblies comprising a roller support member, two roller sets, one spring member, a roller set assembly support, and an adjustable set screw; and two second roller set assemblies comprising a roller support member, two roller sets, and a roller set assembly support, wherein the second relatively slidable member is a rectangular shaped member.
